(19) United States
(12) Patent Application Publication
(10) Pub. No.: US 2015/0220310 A1
(43) Pub. Date: Aug. 6, 2015

(54) OBJECT FIELD OPTIMIZATION

(71) Applicant: International Business Machines Corporation, Armonk, NY (US)

(72) Inventors: Dustin K. Amrhein, Zachary, LA (US); Kulvir S. Bhogal, Fort Worth, TX (US); Nitin Gaur, Round Rock, TX (US); Christopher D. Johnson, Rochester, MN (US); Brian K. Martin, Cary, NC (US)

(73) Assignee: International Business Machines Corporation, Armonk, NY (US)

(21) Appl. No.: 14/170,673

(22) Filed: Feb. 3, 2014

(51) Int. Cl. G06F 9/44

(52) U.S. Cl. CPC G06F 8/315

(57) ABSTRACT

Embodiments of the present invention disclose a method, computer program product, and system for optimizing objects in object oriented programming. A computer receives application code having a plurality of application object fields. The computer receives information detailing a set of user-defined classes, wherein the user-defined classes include at least one object field. The computer analyzes the plurality of application object fields and the information detailing the set of user-defined classes to identify at least one object field in the set of user-defined classes that does not appear in the plurality of application object fields. The computer generates an instance of at least one user-defined class of the set of user-defined classes, wherein the instance does not include the at least one object field that does not appear in the plurality of application object fields.

### FIELD OF THE INVENTION

The present invention relates generally to the field of object-oriented programming, and more particularly to object field optimization.

### BACKGROUND OF THE INVENTION

In object-oriented programming, a class is a construct used to define a distinct type of object. Objects are specific locations in a computer system's physical memory that have a specified value and can be referenced by an identifier. Objects can be variables, functions, or data structures, such as lists or dictionaries. Object fields (or data fields) define the specific values associated with objects. A single object can have one or multiple object fields associated with it. Each object field includes an associated name. For example, the object fields for an object that represents a rectangle can include one object field named “height” and one object field named “width.”

Classes are templates used to create objects. Classes include basic information regarding specific objects that are members of a class. An object that is a member of a given class is called an instance of the class. Classes can include information such as the data fields that an instance of the class must have. Additionally, classes can define variables and methods that are associated with a particular instance of the class. Applications call on a class in order to instantiate the class into an instance of that class for use by the application. Each instance of a class has the attributes of the class, but is distinct from other instances of the class. Instances of a class share attributes of a class that are defined by data fields, member variables, or instance variables. In some programming languages, the data fields are specific field types and names that associate the instance with state variables at program runtime. Methods define the behavior of a class or instances of a class. Methods are subroutines with the ability to operate on objects or classes. These operations may alter the state of an object or provide a means for accessing the object or class.

Some object oriented programming languages, such as Java®, include a form of syntactic metadata called an annotation, or an attribute. Classes, methods, variables, and data fields may be annotated. Annotations can define the manner in which programs interact with the application objects.

### SUMMARY

Embodiments of the present invention disclose a method, computer program product, and system for optimizing objects in object oriented programming. A computer receives application code having a plurality of application object fields. The computer receives information detailing a set of user-defined classes, wherein the user-defined classes include at least one object field. The computer analyzes the plurality of application object fields and the information detailing the set of user-defined classes to identify at least one object field in the set of user-defined classes that does not appear in the plurality of application object fields. The computer generates an instance of at least one user-defined class of the set of user-defined classes, wherein the instance does not include the at least object field that does not appear in the plurality of application object fields.

### BRIEF DESCRIPTION OF THE SEVERAL VIEWS OF THE DRAWINGS

FIG. 1 is a functional block diagram illustrating a computing environment, in accordance with an embodiment of the present invention.

FIG. 2 is a flowchart depicting operational steps of an optimization program, on a server computer within the data computing environment of FIG. 1, for optimizing a given set of objects, in accordance with an embodiment of the present invention.

FIG. 3 is a flowchart depicting operational steps of an optimization program, on a server computer within the data computing environment of FIG. 1, for optimizing a given set of objects, in accordance with an illustrative embodiment of the present invention.

FIG. 4 depicts a block diagram of components of the server computer executing the optimization program, in accordance with an embodiment of the present invention.

### DETAILED DESCRIPTION

Embodiments of the present invention recognize that customers sometimes define object classes that include more data fields than a particular application needs to access. While this practice gives the object versatility, e.g., multiple applications can share a common object, it can increase the object in-memory storage and the serialization size when transmitting the field value objects on a communications network. Therefore, in order to reduce the object in-memory storage and/or serialization size, instantiating a particular class with only the necessary fields is desirable. Additionally, allowing a user, such as the author of the application code, to designate those classes to be reduced allows for customization and efficient management of the application code.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network (LAN), a wide area network (WAN), and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk®, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

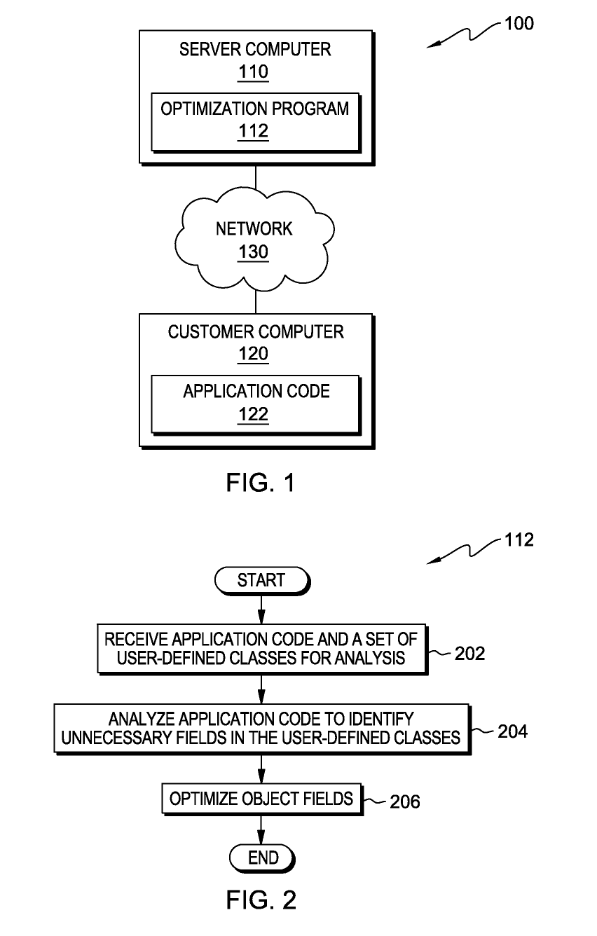

The present invention will now be described in detail with reference to the Figures. FIG. 1 is a functional block diagram illustrating a computing environment, generally designated 100, in accordance with an embodiment of the present invention.

Computing environment 100 includes server computer 110 and customer computer 120 interconnected over network 130. Network 130 can be, for example, a local area network (LAN), a wide area network (WAN) such as the Internet, or a combination of the two, and can include wired, wireless, or fiber optic connections. In general, network 130 can be any combination of connections and protocols that will support communications between server computer 110 and customer device 120.

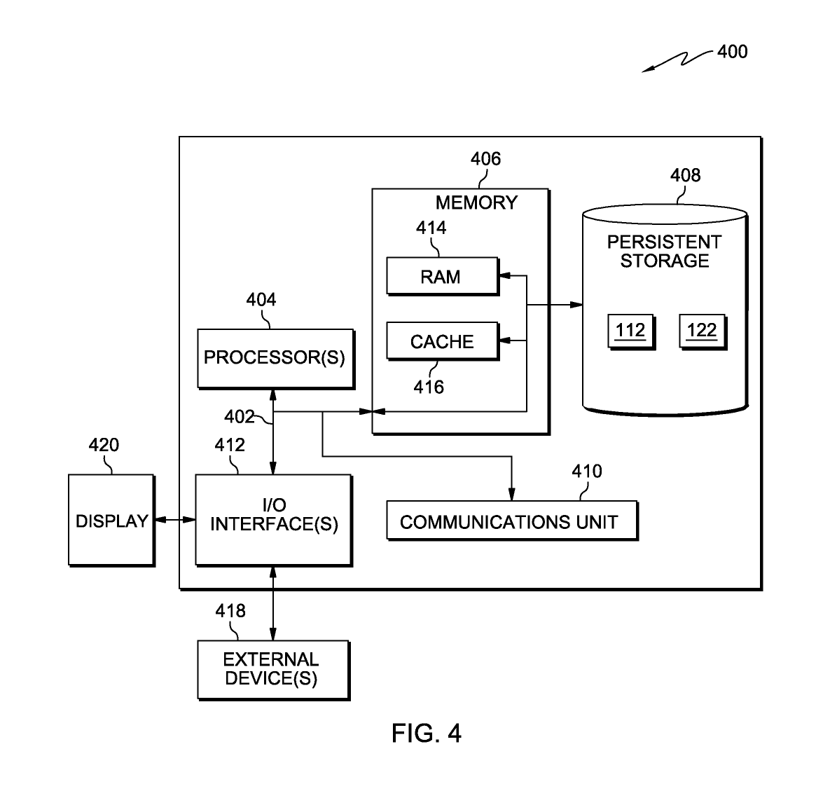

In various embodiments of the present invention, server computer 110 and customer computer 120 may be laptop computers, tablet computers, netbook computers, personal computers (PC), desktop computers, personal digital assistants (PDA), smart phones, or any programmable electronic devices capable of communicating via network 130. In another embodiment, server computer 110 and customer computer 120 represent a computing system utilizing clustered computers and components to act as a single pool of seamless resources. In general, server computer 110 and customer computer 120 can be any computing devices or combination of devices that have access to application code 122 and optimization program 112 and are capable of running optimization program 112. Server computer 110 and customer computer 120 may include internal and external hardware components, as depicted and described in further detail with respect to FIG. 4. In one embodiment, server computer 110 includes optimization program 112 and customer computer 120 includes application code 122. In another embodiment, optimization program 112 and application code 122 are stored on a single computer system, such as customer computer 120.

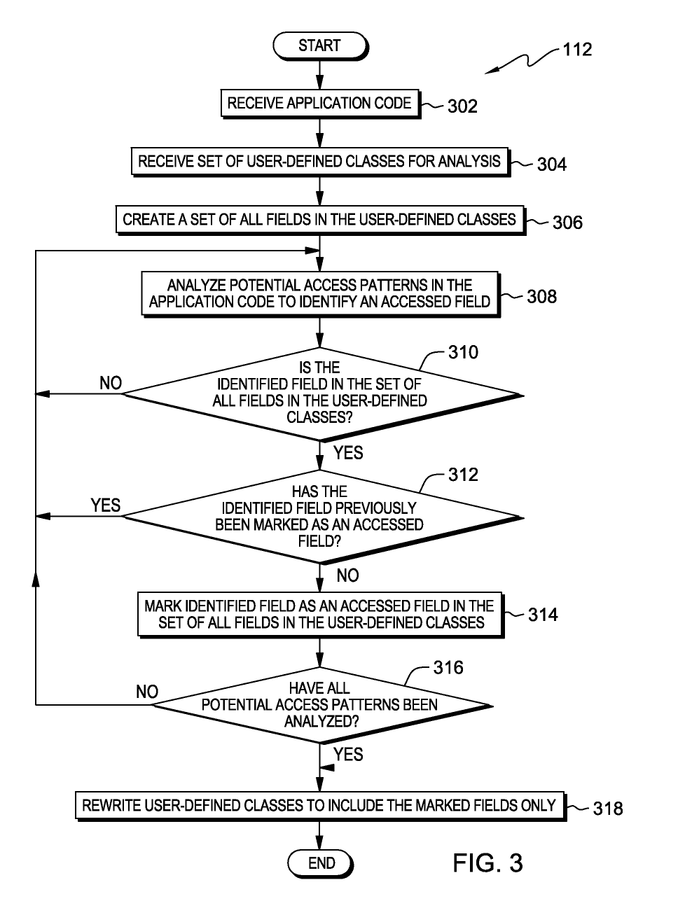

In computing environment 100 depicted in FIG. 1, Optimization program 112 resides on server computer 110 and analyzes application code 122, stored on customer computer 120, in order to optimize object fields in the objects accessed by application code 122. Optimization program 112 receives application code 122 and a set of user-defined classes to be optimized. Optimization program 112 analyzes application code 122 to identify the fields in the user-defined classes that are used or not used by application code 122. Optimization program 112 outputs a set of optimized user-defined classes. The functionality of optimization program 112 is discussed in further detail with regard to FIGS. 2 and 3.

In computing environment 100 depicted in FIG. 1, application code 122 resides on customer computer 120. In another embodiment, application code 122 resides on the same computing system as optimization program 112. Application code 122 includes object-oriented program code that accesses a number of classes. Application code 122 can include source code, byte code, or compiled code that may be executed on a computer system, such as customer computer 120. In one embodiment, application code 122 is source code, such as Java® source code, that is ready to be compiled into byte code for execution on a virtual machine, such as the Java® virtual machine (JVM).

FIG. 2 is a flowchart depicting operational steps of an optimization program, on a server computer within the data computing environment of FIG. 1, for optimizing a given set of objects, in accordance with an embodiment of the present invention.

Optimization program 112 receives application code 122 and a set of user-defined classes for analysis via network 130 (step 202). In one embodiment, the set of user-defined classes for analysis is input by a user of customer computer 120 via a user interface and includes the complete classpath for application 122. A classpath is a parameter that instructs the computer executing an application where to find the classes that the application calls. For example, in Java® programming, the classpath provides an address to the JVM where the JVM can access the classes and packages that the application uses. In another embodiment, the user of customer computer 120 defines a set of object classes to be analyzed by optimization program 112. The user-defined set of object classes can be either the entire classpath or a subset of the classes included in the classpath for application 122.

Optimization program 112 analyzes the application code to identify unnecessary fields in the user-defined classes (step 204). Unnecessary fields are those fields that are included in a particular class that an application code 122 calls, but are not used by application code 122. Optimization program 112 identifies unnecessary fields by locating object fields in application code 122 and denoting a field as accessed in the user-defined set of classes. When optimization program 112 finishes identifying all object fields in application code 122, those fields which are not marked in the user-defined set of classes represent the unnecessary fields. Optimization program 112 performs the analysis of application code 112 by scanning all potential access paths in application code 122 to locate object fields. Access paths include all unique logical paths that application code 122 can follow when executed by customer computer 120. In one embodiment, optimization program 112 generates a set of all fields included in the user-defined classes. In one embodiment, optimization program 112 scans application code 122 until it identifies an object field that is part of one of the user-defined classes. In this embodiment, optimization program 112 has the ability to mark or tag the field in the class, or in the set of fields contained in the user-defined classes, in order to denote that the application accesses the field. Object fields that are not accessed by the application and, therefore, not marked by optimization program 112, are deemed unnecessary object fields. Optimization program 112 continues to scan application code 122 until it has analyzed all of the potential access patterns to the analyzed objects.

Optimization program 112 optimizes the object fields (step 206). Optimization program 112 performs an optimization action and outputs the results of the analysis. The optimization action can include optimization program 112 rewriting the set of user-defined classes so that only the accessed object fields remain in the set of user-defined classes while removing the unnecessary fields. In one embodiment, optimization program 112 rewrites the code for the user-defined classes to remove all of the fields in those classes that application code 122 does not access, i.e., all fields that were not marked by optimization program 112. In another embodiment, optimization program 112 adds annotations to the fields in the user-defined classes that indicate which fields can be accessed by application code 122. In one embodiment, the annotations include subroutines that instruct application code 122 which fields need to be retrieved and serialized from a data source, such as a cache.

FIG. 3 is a flowchart depicting operational steps of an optimization program, on a server computer within the data computing environment of FIG. 1, for optimizing a given set of objects, in accordance with an illustrative embodiment of the present invention.

Optimization program 112 receives application code 122 from server computer 110 via network 130 (step 302). Optimization program 112 receives a set of user-defined classes for analysis from server computer 110 via network 130 (step 304). A user, such as the author of application code 122, may input a set of classes into server computer 110 via a user interface, to be analyzed by optimization program 112. The user-defined classes can be the entire classpath of the application or a subset of classes included in the classpath for the application.

Optimization program 112 creates a set of all of the fields included in the user-defined classes (step 306). Optimization program 112 scans each class in the user-defined classes and extracts each field in each class in order to create a set of all of the fields included in the user-defined classes. In one embodiment, each field included in the set of fields has the ability to be marked by optimization program 112 to show that the application accesses the field in at least one potential access pattern. For example, a user defines a set of classes that includes the class “customer”, which includes a set fields named “customer_name”, “zip_code”, and “last_purchase_date”, and the class “vendor”, which includes the fields “vendor_name” and “location”. Optimization program 112 generates a set of fields that includes the fields “customer_name”, “zip_code”, “last_purchase_date”, “vendor_name”, and “location”, where each field included in the set has the ability to be marked to designate that the application accesses the field in at least one potential access pattern.

Optimization program 112 analyzes the potential access patterns in the application code to identify an accessed field (step 308). In one embodiment, optimization program 112 analyzes the methods in application code 122 and identifies an object field in application code 122. For example, optimization program 112 proceeds through the logic of application 122 to locate a specific method that will access a field. Optimization program 112 locates the name of the field accessed by the identified method and compares the identified field to the set of all fields in the user-defined classes to determine if the identified field has a corresponding field included in the set of all fields in the set of user-defined classes that shares the same field name.

Optimization program 112 determines if the identified field is included in the set of user-defined classes (decision block 310). Optimization program 112 compares the identified field to each field in the set of user-defined classes to determine if they are substantially similar. Fields are substantially similar if they represent the same trait in both application code 122 and in the set of all fields in the set of user-defined classes. For example, substantially similar fields can have the same field name and the same field value type (e.g., integer or Boolean). If optimization program 112 determines that the identified field is not in the set of all fields in the user-defined classes (decision block 310, NO branch), then optimization program 112 proceeds to continue analyzing the potential access patterns in application code 122 to identify an accessed field in step 308. If optimization program 112 determines that the identified field is in the set of all fields in the user-defined classes (decision block 310, YES branch), then optimization program 112 proceeds to determine whether the field has already been marked in decision block 312.

Optimization program 112 determines whether the identified field is already marked as an accessed field in the set of all fields in the user-defined classes (decision block 312). If optimization program 112 determines that the identified field has already been marked as being accessed by the application in the set of all fields in the user-defined classes (decision block 312, YES branch), then optimization program 112 continues to analyze potential access patterns in application code 122 to identify an accessed field in step 308. If optimization program 112 determines that the identified field has not previously been marked as an accessed field in the set of all fields in the user-defined classes (decision block 312, NO branch), then optimization program 112 proceeds to mark the identified field in step 314.

Optimization program 112 marks the identified field as an accessed field in the set of all fields in the user-defined classes (step 314). In one embodiment, optimization program 112 marks the identified field by inserting an annotation into the set of all fields in the user-defined classes.

Optimization program 112 determines whether all potential access patterns have been analyzed (decision block 316). If optimization program 112 determines that it has not analyzed all of the potential access patterns through which the application could access fields in the set of all fields in the user-defined classes (decision block 316, NO branch), then optimization program 112 continues to analyze potential access patterns in application code 122 to identify an accessed field in step 308. If optimization program 112 determines that it has analyzed all potential access patterns through which the application could access fields in the set of all fields in the user-defined classes (decision block 316, YES branch), then optimization program 112 continues to rewrite the user-defined classes to include the marked fields only in step 318.

Optimization program 112 rewrites the user-defined classes to include the marked fields only (step 318). In one embodiment, optimization program 112 creates a new version of each class in the user-defined classes in which the new versions contain only the fields that optimization program 112 marked. In one embodiment, the new versions of each class are stored on a customer computer, such as customer computer 120. In another embodiment, the new versions of each class are stored on a server computer, such as server computer 110.

FIG. 4 depicts a block diagram of respective components of server computer 110 and customer computer 120, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

Server computer 110 includes communications fabric 402, which provides communications between computer processor(s) 404, memory 406, persistent storage 408, communications unit 410, and input/output (I/O) interface(s) 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer-readable storage media. In this embodiment, memory 406 includes random access memory (RAM) 414 and cache memory 416. In general, memory 406 can include any suitable volatile or non-volatile computer-readable storage media.

Optimization program 112 and application code 122 are stored in persistent storage 408 for execution by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 408 may also be removable. For example, a removable hard drive may be used for persistent storage 408. Other examples include optical and magnetic disks, thumb drives, and smart cards that are inserted into a drive for transfer onto another computer-readable storage medium that is also part of persistent storage 408.

Communications unit 410, in these examples, provides for communications with other data processing systems or devices, including resources of customer computer 120. In these examples, communications unit 410 includes one or more network interface cards. Communications unit 410 may provide communications through the use of either or both physical and wireless communications links. Optimization program 112 and application code 122 may be downloaded to persistent storage 408 through communications unit 410.

I/O interface(s) 412 allows for input and output of data with other devices that may be connected to server computer 110. For example, I/O interface 412 may provide a connection to external devices 418 such as a keyboard, keypad, a touch screen, and/or some other suitable input device. External devices 418 can also include portable computer-readable storage media such as, for example, thumb drives, portable optical or magnetic disks, and memory cards. Software and data used to practice embodiments of the present invention, e.g., optimization program 112 and application code 122, can be stored on such portable computer-readable storage media and can be loaded onto persistent storage 408 via I/O interface(s) 412. I/O interface(s) 412 also connect to a display 420.

Display 420 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. A method for optimizing fields in object oriented programming, the method comprising:
receiving, by one or more computer processors, application code having a plurality of application object fields;
receiving, by one or more computer processors, information detailing a set of user-defined classes, wherein the user-defined classes include at least one object field;
analyzing, by one or more computer processors, the plurality of application object fields and the information detailing the set of user-defined classes to identify at least one object field in the set of user-defined classes that does not appear in the plurality of application object fields; and
generating, by one or more computer processors, an instance of at least one user-defined class of the set of user-defined classes, wherein the instance does not include the at least one object field that does not appear in the plurality of application object fields.

2. The method of claim 1, further comprising:
replacing, by one or more computer processors, the information set of user-defined classes with a second set of user-defined classes, wherein the second set of user-defined classes does not include the application object fields that do not appear in both the application code and the set of user-defined classes.

3. The method of claim 1, further comprising:
inserting, by one or more computer processors, annotations into the information detailing the set of user-defined classes, wherein the annotations indicate at least one object field that is not to be included in the instance of the at least one user-defined class.

4. The method of claim 3, wherein the information detailing the set of user-defined classes is stored in association with metadata, and wherein the annotations are stored in the associated metadata.

5. The method of claim 3, further comprising:
storing, by one or more computer processors, the information detailing the set of user-defined classes on a remote data source;
receiving, by one or more computer processors, a request to generate an instance of at least one of the set of user-defined classes; and
serializing, by one or more computer processors, the information detailing the set of user-defined classes for transmittal over a communications network, wherein the set of user-defined classes does not include the annotated object fields.

6. The method of claim 1, wherein the set of user-defined classes is a complete classpath of the application code.

7. The method of claim 1, wherein analyzing the application code comprises:
identifying, by one or more computer processors, each application object field; comparing, by one or more computer processors, each identified application object field with each object field in the set of user-defined classes; and
determining, by one or more computer processors, that at least one object field in the set of user-defined objects is not substantially similar to at least one application object field.

8. A computer program product for optimizing fields in object oriented programming, the computer program product comprising:
one or more computer-readable storage media and program instructions stored on the one or more computer-readable storage media, the program instructions comprising:
program instructions to receive application code having a plurality of application object fields;
program instructions to receive information detailing a set of user-defined classes, wherein the user-defined classes include at least one object field;
program instructions to analyze the plurality of application object fields and the information detailing the set of user-defined classes to identify at least one object field in the set of user-defined classes that does not appear in the plurality of application object fields; and
program instructions to generate an instance of at least one user-defined class of the set of user-defined classes, wherein the instance does not include the at least one object field that does not appear in the plurality of application object fields.

9. The computer program product of claim 8, further comprising:
program instructions to replace the information set of user-defined classes with a second set of user-defined classes, wherein the second set of user-defined classes does not include the application object fields that do not appear in both the application code and the set of user-defined classes.

10. The computer program product of claim 8, further comprising:
program instructions to insert annotations into the information detailing the set of user-defined classes, wherein the annotations indicate at least one object field that is not to be included in the instance of the at least one user-defined class.

11. The computer program product of claim 10, wherein the information detailing the set of user-defined classes is stored in association with metadata, and wherein the annotations are stored in the associated metadata.

12. The computer program product of claim 10, further comprising:
program instructions to store the information detailing the set of user-defined classes on a remote data source;
program instructions to receive a request to generate an instance of at least one of the set of user-defined classes; and
program instructions to serialize the information detailing the set of user-defined classes for transmittal over a communications network, wherein the set of user-defined classes does not include the annotated object fields.

13. The computer program product of claim 8, wherein the set of user-defined classes is a complete classpath of the application code.

14. The computer program product of claim 8, wherein the program instructions to analyze the application code comprise program instructions to:
identify each application object field;
compare each identified application object field with each object field in the set of user-defined classes; and
determine that at least one object field in the set of user-defined objects is not substantially similar to at least one application object field.

15. A computer system for optimizing fields in object oriented programming, the computer system comprising:
one or more computer processors;
one or more computer-readable storage media;
program instructions stored on the computer-readable storage media for execution by at least one of the one or more processors, the program instructions comprising:
program instructions to receive application code having a plurality of application object fields;
program instructions to receive information detailing a set of user-defined classes, wherein the user-defined classes include at least one object field;
program instructions to analyze the plurality of application object fields and the information detailing the set of user-defined classes to identify at least one object field in the set of user-defined classes that does not appear in the plurality of application object fields; and
program instructions to generate an instance of at least one user-defined class of the set of user-defined classes, wherein the instance does not include the at least one object field that does not appear in the plurality of application object fields.

16. The computer system of claim 15, further comprising:
program instructions to replace the information set of user-defined classes with a second set of user-defined classes, wherein the second set of user-defined classes does not include the application object fields that do not appear in both the application code and the set of user-defined classes.

17. The computer system of claim 15, further comprising:
program instructions to insert annotations into the information detailing the set of user-defined classes, wherein the annotations indicate the at least one object field that is not to be included in the instance of the at least one user-defined class.

18. The computer system of claim 17, wherein the information detailing the set of user-defined classes is stored in association with metadata, and wherein the annotations are stored in the associated metadata.

19. The computer system of claim 17, further comprising:
program instructions to store the information detailing the set of user-defined classes on a remote data source;
program instructions to receive a request to generate an instance of at least one of the set of user-defined classes; and
program instructions to serialize the information detailing the set of user-defined classes for transmittal over a communications network, wherein the set of user-defined classes does not include the annotated object fields.

20. The computer system of claim 15, wherein the program instructions to analyze the application code comprise program instructions to:
identify each application object field;
compare each identified application object field with each object field in the set of user-defined classes; and
determine that at least one object field in the set of user-defined objects is not substantially similar to at least one application object field.
